(19) United States
(12) Patent Application Publication
(10) Pub. No.: US 2025/0211992 A1
(43) Pub. Date: Jun. 26, 2025

(54) UNAUTHORIZED BACKSCATTER DEVICE DETECTION

(71) Applicant: Cisco Technology, Inc., San Jose, CA (US)

(72) Inventors: Indermeet S. GANDHI, San Jose, CA (US); Juan Carlos ZUNIGA, Montreal (CA); Jerome HENRY, Pittsboro, NC (US); Robert E. BARTON, Richmond (CA); Amine CHOUKIR, Ecublens (CH); Domenico FICARA, Essertines-Sur-Yverdon (CH); Sachin D. WAKUDKAR, St-Sulpice (CH)

(21) Appl. No.: 18/797,278

(22) Filed: Aug. 7, 2024

Related U.S. Application Data
(60) Provisional application No. 63/614,528, filed on Dec. 23, 2023.

(51) Int. Cl. H04W 12/122; H04W 12/61

(52) U.S. Cl. CPC H04W 12/122; H04W 12/61

(57) ABSTRACT

The present disclosure describes a network that detects unauthorized backscatter devices using an encrypted bit sequence in discovery frames. An access point includes one or more memories and one or more processors communicatively coupled to the one or more memories. A combination of the one or more processors generates a message that includes an encrypted bit sequence and transmits the message to a first backscatter device. The combination of the one or more processors also receives, from the first backscatter device, a first response to the message and in response to determining that the first response lacks a portion based on the bit sequence, initiates a containment procedure for the first backscatter device.

### CROSS-REFERENCE TO RELATED APPLICATIONS

This application claims benefit of co-pending U.S. provisional patent application Ser. No. 63/614,528 filed Dec. 23, 2023. The aforementioned related patent application is herein incorporated by reference in its entirety.

### TECHNICAL FIELD

Embodiments presented in this disclosure generally relate to wireless communication. More specifically, embodiments disclosed herein relate to techniques for detecting unauthorized backscatter devices.

### BACKGROUND

Backscatter devices harvest electrical energy from wireless signals in the environment. The backscatter devices may then use that electrical energy to perform functions. For example, the backscatter devices may use that electrical energy to generate and transmit messages. A concern has arisen about unauthorized and/or malicious backscatter devices being deployed in wireless networks to cause interference and service degradation. It is difficult, however, to detect and restrict these backscatter devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIGS. 1A and 1B illustrate an example system.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 illustrates an example operation performed by the system of FIG. 1A.

FIG. 6 illustrates an example operation performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network that detects unauthorized backscatter devices using an encrypted bit sequence in discovery frames. According to an embodiment, an access point includes one or more memories and one or more processors communicatively coupled to the one or more memories. A combination of the one or more processors generates a message that includes an encrypted bit sequence and transmits the message to a first backscatter device. The combination of the one or more processors also receives, from the first backscatter device, a first response to the message and in response to determining that the first response lacks a portion based on the bit sequence, initiates a containment procedure for the first backscatter device.

According to another embodiment, a method includes generating a message comprising an encrypted bit sequence and transmitting the message to a first backscatter device. The method also includes receiving, from the first backscatter device, a first response to the message and in response to determining that the first response lacks a portion based on the bit sequence, initiating a containment procedure for the first backscatter device.

According to another embodiment, a non-transitory computer readable medium stores instructions that, when executed by a combination of one or more processors, cause the combination of one or more processors to transmit a discovery frame comprising an encrypted bit sequence and receive, from a first backscatter device, a first response to the discovery frame. The instructions also cause the processor to receive, from a second backscatter device, a second response to the discovery frame and in response to determining that the first response lacks the bit sequence, initiate a containment procedure for the first backscatter device. The instructions further cause the processor to, in response to determining that the second response comprises the bit sequence, classify the second backscatter device as authorized.

### EXAMPLE EMBODIMENTS

The present disclosure describes a wireless network (e.g., a wireless fidelity (WiFi) network) that detects unauthorized backscatter devices (which may also be referred to as ambient power devices). Generally, authorized backscatter devices may be provisioned with an encryption/decryption key (e.g., during onboarding, manufacture, and/or provisioning). Unauthorized backscatter devices lack this key. An access point in the network may transmit a discovery frame to discover backscatter devices in the network. The discovery frame may include an encrypted bit sequence that may be decrypted using the key. When an authorized backscatter device receives the discovery frame, the authorized backscatter device can decrypt the bit sequence using the key and use the energy in the discovery frame to generate and transmit a response that includes a portion based on the bit sequence. For example, the backscatter device may include the bit sequence, an encrypted version of the bit sequence, or a modified version of the bit sequence in the response.

When the access point receives the response, the access point detects the portion based on the bit sequence in the response and determines that the backscatter device is authorized. When an unauthorized backscatter device receives the discovery frame, the unauthorized backscatter device is unable to decrypt the bit sequence. Even though the unauthorized backscatter device may use the energy in the discovery frame to generate and transmit a response, that response does not include the portion based on the bit sequence. As a result, when the access point receives that response, the access point may detect that the response lacks the bit sequence and determine that the backscatter device is unauthorized.

In some embodiments, the network provides several technical advantages. For example, the network may detect when an unauthorized backscatter device is harvesting electrical energy in the network. As another example, the network may perform a containment procedure for unauthorized backscatter devices to limit the impact of the unauthorized backscatter devices on the network, which may reduce interference and service degradation.

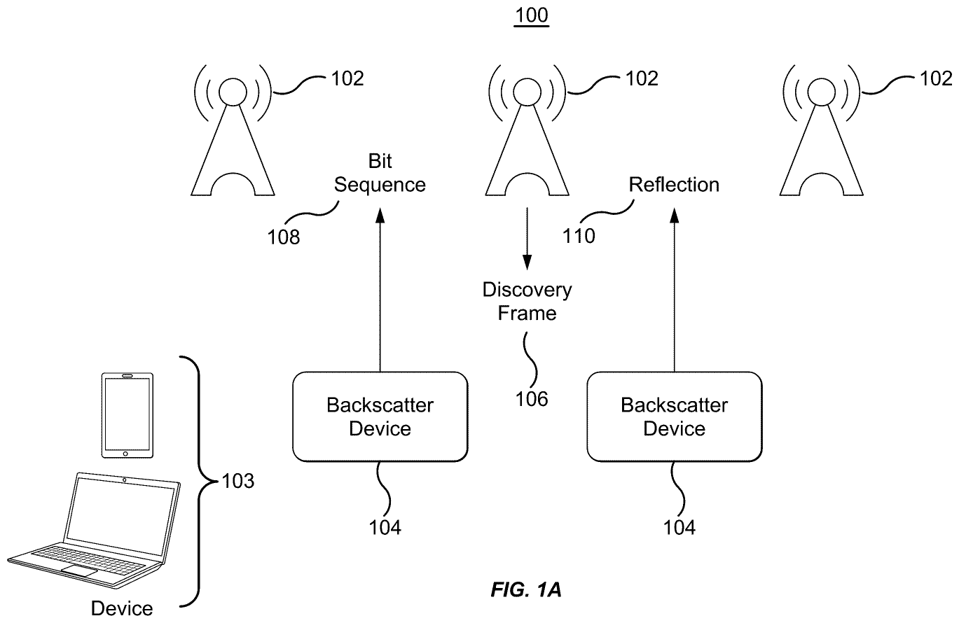

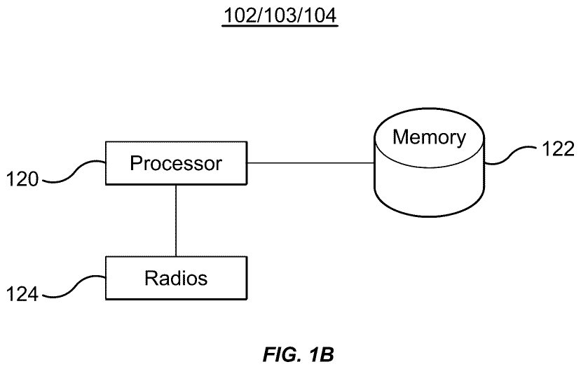

FIG. 1A illustrates an example system 100, which may be a wireless network (e.g., a WiFi network). As seen in FIG. 1A, the system 100 includes one or more access points 102, one or more devices 103, and one or more backscatter devices 104. Generally, the devices 103 and backscatter devices 104 connect to an access point 102. The access point 102 provides network coverage for the system 100. The access point 102 communicates messages to the devices 103 and backscatter devices 104 and directs messages from the devices 103 and backscatter devices 104 towards their destination.

The access point 102 facilitates wireless communication (e.g., WiFi communication) in the system 100. One or more devices 103 or backscatter devices 104 may connect to the access point 102. The access point 102 may then facilitate wireless communication for the connected devices 103 and backscatter devices 104. For example, the access point 102 may transmit messages to a connected device 103 or backscatter device 104. As another example, the access point 102 may receive messages transmitted by the device 103 or backscatter device 104. The access point 102 may then direct that message towards its intended destination.

The device 103 may be any suitable device that wirelessly connects to the access point 102. As an example and not by way of limitation, the device 103 may be a computer, a laptop, a wireless or cellular telephone, an electronic notebook, a personal digital assistant, a tablet, or any other device capable of receiving, processing, storing, or communicating information with other components of the system 100. The device 103 may be a wearable device such as a virtual reality or augmented reality headset, a smart watch, or smart glasses. The device 103 may also include a user interface, such as a display, a microphone, keypad, or other appropriate terminal equipment usable by the user. The device 103 may include a hardware processor, memory, or circuitry configured to perform any of the functions or actions of the device 103 described herein. For example, a software application designed using software code may be stored in the memory and executed by the processor to perform the functions of the device 103.

The backscatter device 104 may be a device that relies on electrical energy in signals transmitted by the access points 102 to power the operations of the backscatter device 104. For example, the backscatter device 104 may receive wireless signals in the system 100 (e.g., signals transmitted by the access points 102). The backscatter device 104 then uses the energy in the signals to modify the signals with encoded data and to reflect the modified signals. The access points 102, devices 103, and/or other backscatter devices 104 may then receive or detect the reflected signals with the encoded data. Existing networks, however, may not have a mechanism to detect and prevent unauthorized backscatter devices from using the electrical energy in the wireless signals in the network to perform malicious operations. For example, these backscatter devices may reflect or transmit messages that cause interference and service degradation.

The access points 102 in the system 100 may perform a technique for detecting unauthorized backscatter devices. Generally, authorized backscatter devices 104 may be provisioned with a key (e.g., during manufacture or during association with an access point 102). Unauthorized backscatter devices would not be provisioned with the key. When an access point 102 transmits a discovery frame 106 from which backscatter devices 104 may harvest electrical energy, the access point 102 may include an encrypted bit sequence 108 in the discovery frame 106. When an authorized backscatter device 104 receives the discovery frame 106, the authorized backscatter device 104 recognizes the encrypted bit sequence 108 and uses the provisioned key to decrypt the bit sequence 108. The authorized backscatter device 104 then includes a portion based on the bit sequence 108 in the reflected signal. For example, the backscatter device 104 may include the bit sequence 108, an encrypted version of the bit sequence 108, or a modified version of the bit sequence 108 in the reflected signal. When the access point 102 receives the reflected signal, the access point 102 detects portion based on the bit sequence 108 in the reflected signal and determines that the backscatter device 104 is authorized.

When an unauthorized backscatter device 104 receives the discovery frame 106, the unauthorized backscatter device 104 may not recognize and/or may not be able to decrypt the encrypted bit sequence 108, because the unauthorized backscatter device 104 does not have the key. As a result, the unauthorized backscatter device 104 may not include the portion based on the bit sequence 108 in the reflected signal. When the access point 102 receives the reflected signal, the access point 102 determines that the portion based on the bit sequence 108 is absent and determines that the backscatter device 104 is unauthorized.

In some embodiments, the authorized backscatter devices 104 are provisioned with key pairs that can be used for encryption and decryption. The authorized backscatter devices 104 may re-encrypt the bit sequence 108 before including the re-encrypted bit sequence 108 in the reflected signal. When the access point 102 receives the reflected signal, the access point 102 may decrypt the re-encrypted bit sequence 108 in the reflected signal.

In the example of FIG. 1A, the backscatter device 104A is authorized and the backscatter device 104B is unauthorized. The backscatter device 104A receives the discovery frame 106 from the access point 102 and decrypts the bit sequence 108 in the discovery frame 106. The backscatter device 104A then includes the portion based on the bit sequence 108 (e.g., the bit sequence 108 itself) in a reflected signal. The backscatter device 104B receives the discovery frame 106 from the access point 102 and does not decrypt the bit sequence 108 in the discovery frame 106. The backscatter device 104B generates the reflection 110. When the access point 102 receives the reflection 110, the access point 102 determines that the reflection 110 does not include the portion based on the bit sequence 108 and determines that the backscatter device 104B is unauthorized. In some embodiments, the access point 102 initiates a containment procedure for the backscatter device 104B in response to determining that the backscatter device 104B is unauthorized.

FIG. 1B illustrates an example access point 102, device 103, or backscatter device 104 in the system 100 of FIG. 1A. As seen in FIG. 1B, the access point 102, device 103, or backscatter device 104 includes a processor 120, a memory 122, and one or more radios 124.

The processor 120 is any electronic circuitry, including, but not limited to one or a combination of microprocessors, microcontrollers, application specific integrated circuits (ASIC), application specific instruction set processor (ASIP), and/or state machines, that communicatively couples to the memory 122 and controls the operation of the access point 102, device 103, and/or backscatter device 104. The processor 120 may be 8-bit, 16-bit, 32-bit, 64-bit or of any other suitable architecture. The processor 120 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 120 may include other hardware that operates software to control and process information. The processor 120 executes software stored on the memory 122 to perform any of the functions described herein. The processor 120 controls the operation and administration of the access point 102, device 103, and/or backscatter device 104 by processing information (e.g., information received from the memory 122 and radios 124). The processor 120 is not limited to a single processing device and may encompass multiple processing devices contained in the same device or computer or distributed across multiple devices or computers. The processor 120 is considered to perform a set of functions or actions if the multiple processing devices collectively perform the set of functions or actions, even if different processing devices perform different functions or actions in the set.

The memory 122 may store, either permanently or temporarily, data, operational software, or other information for the processor 120. The memory 122 may include any one or a combination of volatile or non-volatile local or remote devices suitable for storing information. For example, the memory 122 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 122, a disk, a CD, or a flash drive. In particular embodiments, the software may include an application executable by the processor 120 to perform one or more of the functions described herein. The memory 122 is not limited to a single memory and may encompass multiple memories contained in the same device or computer or distributed across multiple devices or computers. The memory 122 is considered to store a set of data, operational software, or information if the multiple memories collectively store the set of data, operational software, or information, even if different memories store different portions of the data, operational software, or information in the set.

The radios 124 may communicate messages or information using different communication technologies. For example, the access point 102, device 103, and/or backscatter device 104 may use one or more of the radios 124 for WiFi communications. The access point 102, device 103, and/or backscatter device 104 may use one or more of the radios 124 to transmit messages and one or more of the radios 124 to receive messages. The access point 102, device 103, and/or backscatter device 104 may include any number of radios 124 to communicate using any number of communication technologies.

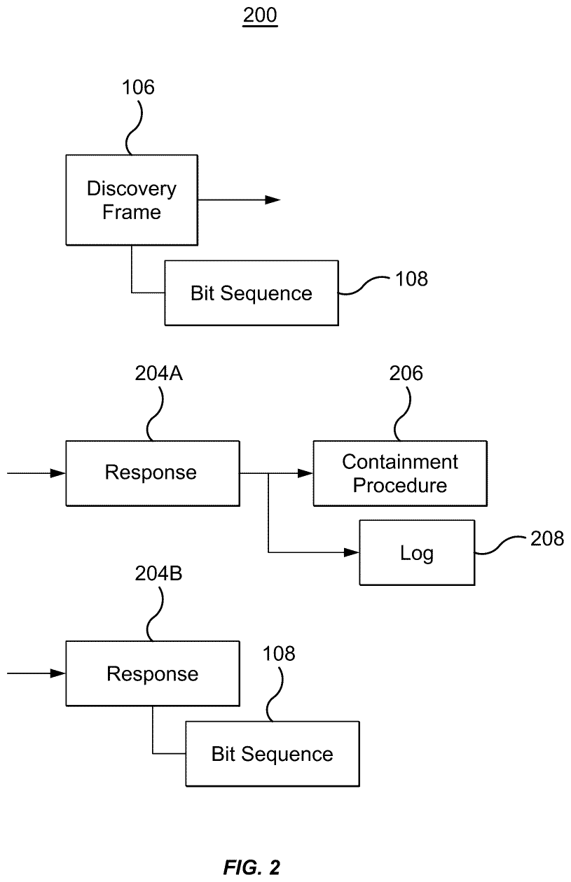

FIG. 2 illustrates an example operation 200 performed by the system 100 of FIG. 1A. Generally, the access point 102 performs the operation 200. By performing the operation 200, the access point 102 detects unauthorized backscatter devices 104 in the system 100.

The access point 102 begins by generating and transmitting a discovery frame 106. The discovery frame 106 may include segments or portions that backscatter devices 104 may use to power message transmission or reflection. In some instances, the access point 102 transmits the discovery frame 106 to determine the backscatter devices 104 in the system 100. The access point 102 includes the bit sequence 108 in the discovery frame 106. The access point 102 encrypts the bit sequence 108 in the discovery frame 106. Authorized backscatter devices 104 in the system 100 may detect and decrypt the bit sequence 108 when the authorized backscatter devices 104 receive the discovery frame 106.

The access point 102 receives responses 204 to the discovery frame 106. In the example of FIG. 2, the access point 102 receives the responses 204A and 204B to the discovery frame 106 (which may be reflections 110). The responses 204A and 204B are generated by different backscatter devices 104 in the system 100. The access point 102 receives the response 204A and determines whether the response 204A includes the portion based on the bit sequence 108 (e.g., the bit sequence 108 itself). The response 204A lacks the portion based on the bit sequence 108, which indicates that the backscatter device 104 that generated the response 204A did not detect and decrypt the bit sequence 108 in the discovery frame 106. In response, the access point 102 may classify that backscatter device 104 as an unauthorized backscatter device 104. The access point 102 then initiates a containment procedure 206 for that backscatter device 104. During the containment procedure 206, the access point 102 may alert other access points 102 in the system 100 that the backscatter device 104 is unauthorized. Additionally, these access points 102 may begin ignoring, discarding, or disregarding messages from that backscatter device 104. In some instances, the access points 102 may direct signals away from that backscatter device 104. If that backscatter device 104 attempts to associate with or connect to the access points 102, the access points 102 may reject the association or connection requests. In this manner, the access points 102 effectively prevent the backscatter device 104 from communicating in the system 100.

In some embodiments, the access point 102 adds an identifier for the backscatter device 104 to a log 208. The log 208 may be shared amongst the access point 102 in the system 100 to track the backscatter devices 104 in the system 100 that are unauthorized. In this manner, if the backscatter device 104 appears at a later time in the system 100, the access points 102 may determine from the log 208 that the backscatter device 104 is unauthorized.

In certain embodiments, the access point 102 may determine a location of positioning of the unauthorized backscatter device 104. For example, the access point 102 may use ranging or location techniques (e.g., fine timing measurement exchanges, received signal strength indicators, and/or triangulation with other access points or devices) to determine where the unauthorized backscatter device 104 is in the system 100. The access point 102 may report the location of the unauthorized backscatter device 104 to other access points. In this manner, the access point 102 alerts other access points 102 in the system 100 about the presence and location of the unauthorized backscatter device 104.

The response 204B is generated by a backscatter device 104 that is authorized. When the access point 102 receives the response 204B, the access point 102 determines that the response 204B includes the portion based on the bit sequence 108 (e.g., the bit sequence 108 itself). As a result, the access point 102 may determine that the backscatter device 104 that generated the response 204B was able to detect and decrypt the bit sequence 108 in the discovery frame 106. In response, the access point 102 classifies that backscatter device 104 as an authorized backscatter device 104. The access point 102 may then accept messages generated or transmitted by that backscatter device 104. The access point 102 may also direct future messages (e.g., energizing frames) towards that backscatter device 104.

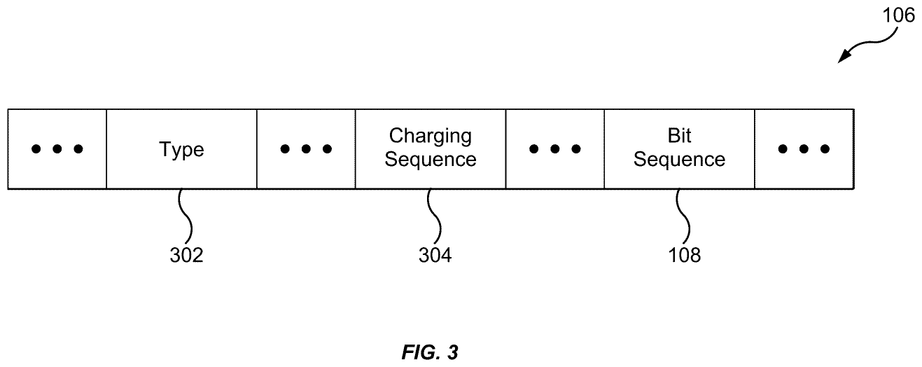

FIG. 3 illustrates an example discovery frame 106 in the system 100 of FIG. 1A. The access point 102 may generate and transmit the discovery frame 106 to determine the backscatter devices 104 in the system 100. As seen in FIG. 3, the discovery frame 106 includes a type 302, a charging sequence 304, and the bit sequence 108. The discovery frame 106 may include other information not shown in FIG. 3.

The type 302 may be a field whose value indicates that the discovery frame 106 is a discovery frame intended for backscatter devices 104 (as opposed to a message intended for another device 103). The access point 102 may adjust the value for the type 302 when the access point 102 is transmitting a message for the device 103 rather than the backscatter device 104. When a backscatter device 104 receives the discovery frame 106, the backscatter device 104 may inspect the type 302 to determine whether the discovery frame 106 is intended for the backscatter device 104.

The charging sequence 304 is a segment or portion of the discovery frame 106 that the backscatter device 104 uses to generate the response 204 (which may be the reflection 110). For example, the backscatter device 104 may use the electrical energy in the charging sequence 304 to generate the response 204. The backscatter device 104 may modify a portion of the charging sequence 304 to generate the response 204 (which may be considered a reflection of the energy in the charging sequence 304). The backscatter device 104 may also use some of the energy in the charging sequence 304 to transmit the response 204.

The bit sequence 108 in the discovery frame 106 may be encrypted by the access point 102. If the backscatter device 104 that receives the discovery frame 106 is an authorized backscatter device 104, then the backscatter device 104 may be provisioned with a key that can decrypt the bit sequence 108 in the discovery frame 106. The authorized backscatter device 104 may detect the encrypted bit sequence 108 and use the key to decrypt the bit sequence 108. The backscatter device 104 then includes the bit sequence 108 in the response 204 generated by the backscatter device 104. In some embodiments, the backscatter device 104 re-encrypts or modifies the bit sequence 108 and includes the re-encrypted or modified bit sequence 108 in the response 204. When the access point 102 receives the response 204 and detects the bit sequence 108, the re-encrypted bit sequence 108, or the modified bit sequence 108 in the response 204, the access point 102 determines that the backscatter device 104 is authorized. The access point 102 may decrypt the response 204 and/or the re-encrypted bit sequence 108.

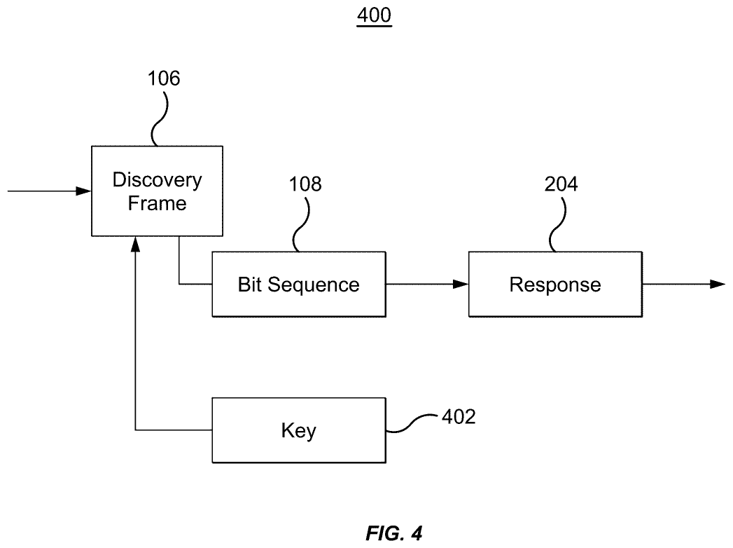

FIG. 4 illustrates an example operation 400 performed by the system 100 of FIG. 1A. Generally, a backscatter device 104 in the system 100 performs the operation 400. By performing the operation 400, the backscatter device 104 indicates to the access point 102 that the backscatter device 104 is authorized.

The backscatter device 104 receives the discovery frame 106 from the access point 102. The discovery frame 106 may signal to the backscatter device 104 that the backscatter device 104 should respond to the discovery frame 106 so that the access point 102 may determine or detect the presence of the backscatter device 104. The backscatter device 104 analyzes the discovery frame 106 to determine whether the discovery frame 106 includes an encrypted bit sequence 108. The backscatter device 104 may have been provisioned with a key 402 that may be used to decrypt the bit sequence 108 in the discovery frame 106. When the access point 102 detects that the discovery frame 106 includes the encrypted bit sequence 108, the backscatter device 104 uses the key 402 to decrypt the bit sequence 108 in the discovery frame 106.

The backscatter device 104 then generates the response 204 to the discovery frame 106. The backscatter device 104 may use electrical energy in the discovery frame 106 to modify portions of the discovery frame 106 to generate the response 204, which may generate a reflection of the energy in the discovery frame 106. In this manner, the response 204 is a reflection 110 of portions of the discovery frame 106. Additionally, the backscatter device 104 adds a portion based on the bit sequence 108 to the response 204. For example, the backscatter device 104 may add the bit sequence 108 itself to the response 204. As another example, the backscatter device 104 may re-encrypt the bit sequence 108 and add the re-encrypted bit sequence 108 to the response 204. As another example, the backscatter device 104 may modify the bit sequence 108 and include the modified bit sequence 108 in the response 204. The modification may be a modification known by the access point 102, and the access point 102 may have indicated the modification to the backscatter device 104. The modification may include an operation or function that uses the bit sequence 108 to generate another sequence that is considered the modified bit sequence. The backscatter device 104 then transmits the response 204 to the access point 102. In this manner, the backscatter device 104 signals to the access point 102 that the backscatter device 104 is authorized.

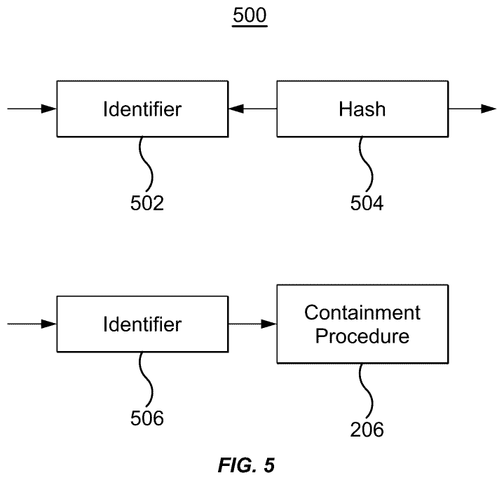

FIG. 5 illustrates an example operation 500 performed by the system 100 of FIG. 1A. Generally, the access point 102 performs the operation 500. By performing the operation 500, the access point 102 identifies and segregates authorized and unauthorized backscatter devices 104.

The access point 102 may receive or determine an identifier 502 for a backscatter device 104. The identifier 502 may have been included in the response 204 to the discovery frame 106 from the backscatter device 104. When the access point 102 determines that the response 204 includes the portion based on the bit sequence 108, the access point 102 determines that the backscatter device 104 with the identifier 502 is authorized. In response, the access point 102 generates and tags the backscatter device 104 with a hash 504. For example, the access point 102 may store the hash 504. Additionally, the access point 102 may send the hash 504 to the backscatter device 104. The hash 504 may subsequently be used to indicate that the backscatter device 104 is authorized.

The access point 102 may determine or receive an identifier 506 from another backscatter device 104. The identifier 506 may have been included in the response 204 to the discovery frame 106 from the backscatter device 104. When the access point 102 determines that the response 204 does not include the portion based on the bit sequence 108, the access point 102 may determine that the backscatter device 104 is unauthorized. In response, the access point 102 does not send or tag the backscatter device 104 with the hash 504. Instead, the access point 102 may initiate the containment procedure 206 for the backscatter device 104. If the backscatter device 104 subsequently attempts to associate with or connect to the access point 102, the access point 102 may determine that the backscatter device 104 is not tagged with the hash 504. In response, the access point 102 may continue to determine that the backscatter device 104 is unauthorized. Additionally, the access point 102 may direct subsequent messages (e.g., energizing frames) away from the backscatter device 104, and the access point 102 may log the backscatter device 104 as unauthorized.

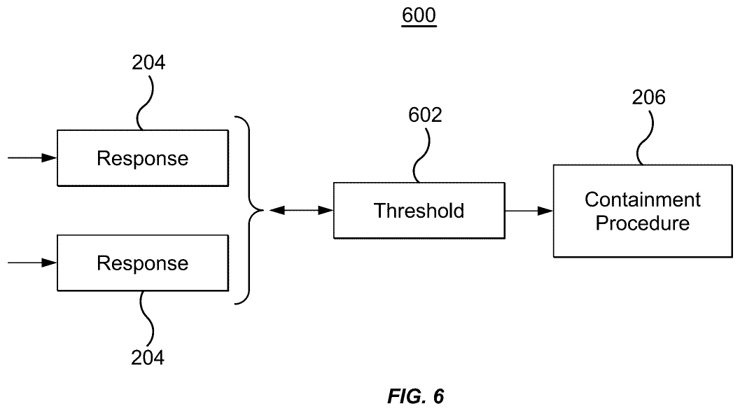

FIG. 6 illustrates an example operation 600 performed by the system 100 of FIG. 1A. Generally, the access point 102 performs the operation 600. By performing the operation 600, the access point 102 determines whether a backscatter device 104 is authorized or unauthorized.

The access point 102 may not classify a backscatter device 104 as unauthorized if the backscatter device 104 provides a response 204 that lacks the portion based on the bit sequence 108 one time. Rather, the access point 102 may provide the backscatter device 104 several chances or a period of time in which the backscatter device 104 should provide a response 204 with the portion based on the bit sequence 108. As seen in FIG. 6, the access point 102 receives multiple responses 204 from a backscatter device 104. The access point 102 may determine that these responses 204 lack the portion based on the bit sequence 108. The access point 102 may use a threshold 602 to determine whether the backscatter device 104 is unauthorized. For example, the access point 102 may determine whether the number of responses 204 from the backscatter device 104 that lacked the portion based on the bit sequence 108 exceeds a numerical threshold 602. As another example, the access point 102 may determine whether an amount of time in which the backscatter device 104 has not provided a response 204 that includes the portion based on the bit sequence 108 has exceeded a time threshold 602.

If the threshold 602 is exceeded, the access point 102 may classify the backscatter device 104 as unauthorized. The access point 102 may then initiate the containment procedure 206 for the backscatter device 104. For example, the access point 102 may begin ignoring, discarding, or disregarding messages from the backscatter device 104. The access point 102 may also begin rejecting association or connection requests from the backscatter device 104. Additionally, the access point 102 may direct subsequent messages (e.g., energizing frames) away from the backscatter device 104, and the access point 102 may log the backscatter device 104 as unauthorized.

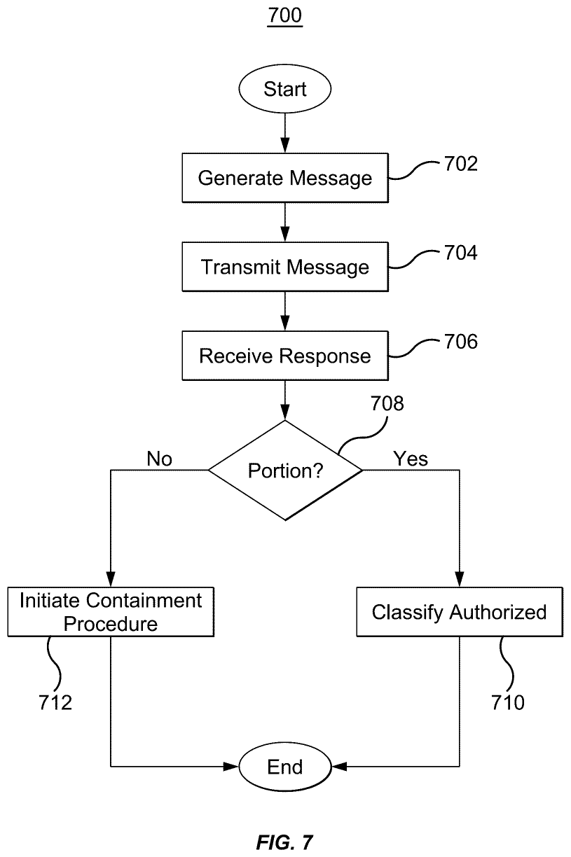

FIG. 7 is a flowchart of an example method 700 performed by the system 100 of FIG. 1A. In particular embodiments, the access point 102 performs the method 700. By performing the method 700, the access point 102 determines whether a backscatter device 104 is authorized or unauthorized.

In block 702, the access point 102 begins by generating a message. The message may be the discovery frame 106. The message may include an encrypted bit sequence 108 that authorized backscatter devices 104 can decrypt. Unauthorized backscatter devices 104 may not be able to decrypt the encrypted bit sequence 108 in the message. In block 704, the access point 102 transmits the message.

In block 706, the access point 102 receives a response 204 to the message from a backscatter device 104. The response 204 may be the reflection 110 from the backscatter device 104. In block 708, the access point 102 determines whether the response 204 includes the portion based on the bit sequence 108 (e.g., the bit sequence 108 itself, an encrypted version of the bit sequence 108, or a modified version of the bit sequence 108). If the response 204 includes the portion based on the bit sequence 108, the access point 102 classifies the backscatter device 104 as authorized in block 710. If the response 204 lacks the portion based on the bit sequence 108, then the access point 102 classifies the backscatter device 104 as unauthorized. Then, the access point 102 initiates the containment procedure 206 for the access point 102 in block 712. By initiating the containment procedure 206, the access point 102 may prevent the backscatter device 104 from further impacting the system 100.

In summary, the access point 102 detects unauthorized backscatter devices 104. Generally, authorized backscatter devices 104 may be provisioned with an encryption/decryption key (e.g., during onboarding, manufacture, and/or provisioning). Unauthorized backscatter devices 104 lack this key. The access point 102 may transmit a discovery frame to discover backscatter devices 104 in the network. The discovery frame may include an encrypted bit sequence that may be decrypted using the key. When an authorized backscatter device 104 receives the discovery frame, the authorized backscatter device 104 can decrypt the bit sequence using the key and use the energy in the discovery frame to generate and transmit a response that includes a portion based on the bit sequence (e.g., the bit sequence itself, an encrypted version of the bit sequence, or a modified version of the bit sequence). When the access point 102 receives the response, the access point 102 detects the portion based on the bit sequence in the response and determines that the backscatter device 104 is authorized. When an unauthorized backscatter device 104 receives the discovery frame, the unauthorized backscatter device 104 is unable to decrypt the bit sequence. Even though the unauthorized backscatter device 104 may use the energy in the discovery frame to generate and transmit a response, that response does not include the portion based on the bit sequence. As a result, when the access point 102 receives that response, the access point 102 may detect that the response lacks the portion based on the bit sequence and determine that the backscatter device 104 is unauthorized.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
one or more memories; and
one or more processors communicatively coupled to the one or more memories, a combination of the one or more processors configured to:
generate a message comprising an encrypted bit sequence;
transmit the message to a first backscatter device;
receive, from the first backscatter device, a first response to the message; and
in response to determining that the first response lacks a portion based on the bit sequence, initiate a containment procedure for the first backscatter device.

2. The access point of claim 1, wherein the combination of the one or more processors is further configured to determine and report a location of the first backscatter device.

3. The access point of claim 1, wherein the combination of the one or more processors is further configured to:
receive, from a second backscatter device, a second response to the message; and
in response to determining that the second response comprises the portion based on the bit sequence, classify the second backscatter device as authorized.

4. The access point of claim 3, wherein the combination of the one or more processors is further configured to decrypt the second response.

5. The access point of claim 1, wherein the first response comprises a reflection of energy of the message.

6. The access point of claim 1, wherein the combination of the one or more processors is further configured to disregard messages from the first backscatter device in response to determining that the first response lacks the portion based on the bit sequence.

7. The access point of claim 1, wherein initiating the containment procedure is in response to determining that the response exceeded a time threshold.

8. A method comprising:
generating a message comprising an encrypted bit sequence;
transmitting the message to a first backscatter device;
receiving, from the first backscatter device, a first response to the message; and
in response to determining that the first response lacks a portion based on the bit sequence, initiating a containment procedure for the first backscatter device.

9. The method of claim 8, further comprising determining and reporting a location of the first backscatter device.

10. The method of claim 8, further comprising:
receiving, from a second backscatter device, a second response to the message; and
in response to determining that the second response comprises the portion based on the bit sequence, classifying the second backscatter device as authorized.

11. The method of claim 10, further comprising decrypting the second response.

12. The method of claim 8, wherein the first response comprises a reflection of energy of the message.

13. The method of claim 8, further comprising disregarding messages from the first backscatter device in response to determining that the first response lacks the portion based on the bit sequence.

14. The method of claim 8, wherein initiating the containment procedure is in response to determining that the response exceeded a time threshold.

15. A non-transitory computer readable medium storing instructions that, when executed by a combination of one or more processors, cause the combination of one or more processors to:
transmit a discovery frame comprising an encrypted bit sequence;
receive, from a first backscatter device, a first response to the discovery frame;
receive, from a second backscatter device, a second response to the discovery frame;
in response to determining that the first response lacks the bit sequence, initiate a containment procedure for the first backscatter device; and
in response to determining that the second response comprises the bit sequence, classify the second backscatter device as authorized.

16. The medium of claim 15, wherein the instructions further cause the combination of one or more processors to determine and report a location of the first backscatter device.

17. The medium of claim 15, wherein the instructions further cause the combination of one or more processors to decrypt the second response.

18. The medium of claim 15, wherein the first response comprises a reflection of energy of the discovery frame.

19. The medium of claim 15, wherein the instructions further cause the combination of one or more processors to disregard messages from the first backscatter device in response to determining that the first response lacks the bit sequence.

20. The medium of claim 15, wherein initiating the containment procedure is in response to determining that the response exceeded a time threshold.
